(19) United States
(12) Patent Application Publication
(10) Pub. No.: US 2026/0274301 A1
(43) Pub. Date: Sep. 17, 2026

(54) PATTERN RECOGNITION SYSTEM FOR SENSOR CALIBRATION IN AUTONOMOUS VEHICLES

(71) Applicant: Torc Robotics, Inc., Blacksburg, VA (US)

(72) Inventors: Simon Baeuerle, Kassel (DE); Maximilian Koeper, Ostfildern (DE); Maximilian Yassine Beyen, Leutenbach (DE); Marat Kopytjuk, Heilbronn (DE); Margarita Kunjavskaja, Gerlingen (DE)

(21) Appl. No.: 19/081,806

(22) Filed: Mar. 17, 2025

(51) Int. Cl. B60W 60/00; B60W 50/00; B60W 50/02; G07C 5/00

(52) U.S. Cl. CPC B60W 60/0015; B60W 50/0205; G07C 5/008; B60W 2050/0088; B60W 2050/0215; B60W 2556/10

(57) ABSTRACT

An autonomy computing system for sensor calibration in an autonomous vehicle is provided. The autonomy computing system includes a processor and a memory in communication with the processor. The processor is programmed to retrieve reference data indicating at least one baseline parameter, receive sensor data from at least one sensor of the autonomous vehicle during operation of the autonomous vehicle, the sensor data indicating at least one measured parameter, identify at least one calibration error of the at least one sensor by comparing the at least one measured parameter to the at least one baseline parameter, generate a record in the memory including the at least one calibration error, and control operation of the autonomous vehicle based on the at least one calibration error.

### TECHNICAL FIELD

The field of the disclosure relates generally to autonomous vehicles and, more specifically, to a pattern recognition system for sensor calibration in autonomous vehicles.

### BACKGROUND OF THE INVENTION

Autonomous vehicles utilize sensors such as cameras for planning and controlling operation. These sensors are calibrated to ensure that an environment perceived by the autonomous vehicle accurately reflects the actual environment. Under certain conditions, errors in calibration may form during operation of the autonomous vehicle. While autonomous vehicle sensors can currently be recalibrated in a workshop environment, an ability to identify and correct such errors in real time during operation is desirable.

Additionally, an ability to identify patterns resulting in such calibration errors to enable taking of proactive measures to reduce sensor calibration errors is also desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system for sensor calibration in an autonomous vehicle is provided. The autonomy computing system includes a processor and a memory in communication with the processor. The processor is programmed to retrieve reference data indicating at least one baseline parameter, receive sensor data from at least one sensor of the autonomous vehicle during operation of the autonomous vehicle, the sensor data indicating at least one measured parameter, identify at least one calibration error of the at least one sensor by comparing the at least one measured parameter to the at least one baseline parameter, generate a record in the memory including the at least one calibration error, and control operation of the autonomous vehicle based on the at least one calibration error.

In another aspect, a computer-implemented method for sensor calibration in an autonomous vehicle is provided. The computer-implemented method includes retrieving reference data indicating at least one baseline parameter, receiving sensor data from at least one sensor of the autonomous vehicle during operation of the autonomous vehicle, the sensor data indicating at least one measured parameter, identifying at least one calibration error of the at least one sensor by comparing the at least one measured parameter to the at least one baseline parameter, generating a record in a memory including the at least one calibration error, and controlling operation of the autonomous vehicle based on the at least one calibration error.

In another aspect, an autonomous vehicle is provided. The autonomous vehicle includes at least one sensor and an autonomy computing system including a processor and a memory in communication with the processor. The processor is programmed to retrieve reference data indicating at least one baseline parameter, receive sensor data from the at least one sensor of the autonomous vehicle during operation of the autonomous vehicle, the sensor data indicating at least one measured parameter, identify at least one calibration error of the at least one sensor by comparing the at least one measured parameter to the at least one baseline parameter, generate a record in the memory including the at least one calibration error, and control operation of the autonomous vehicle based on the at least one calibration error.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a flowchart illustrating an example method for sensor calibration in autonomous vehicles;

FIG. 4 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The embodiments described herein include an autonomy computing system for sensor calibration in an autonomous vehicle. The autonomy computing system includes at least one processor and at least one memory device in communication with the processor. As described in further detail below, the autonomy computing system enables detection and identification of sensor calibration errors, generating alerts and actions to correct these identified errors, and identification of patterns that result in sensor calibration errors. While the functions described herein are described as being performed by the autonomy computer system, this example is for illustration purposes only, and in alternative embodiments, these functions may be performed by a computing system separate from the autonomy computing system.

In the example embodiment, to detect and identify calibration errors, the processor is configured to retrieve reference data indicating at least one baseline parameter. The at least one baseline parameter can be, for example, a known physical location of one or more reference features (e.g., signs, objects, or markings along a route). The processor is configured to receive sensor data from at least one sensor of the autonomous vehicle during operation of the autonomous vehicle. This sensor data indicates at least one measured parameter such as, for example, perceived locations of the one or more reference features. The processor is configured to then identify any calibration errors that are present for the at least one sensor by comparing the at least one measured parameter to the at least one baseline parameter. For example, if the location of a reference feature perceived by a certain sensor along a route of the autonomous vehicle differs from a known location of the reference feature, a calibration error may be identified for this sensor. The processor is further configured to generate a record in a memory including identified calibration errors. The records can also include additional data about the identified calibration errors, such as a time stamp, a location, a misalignment type, or environmental data.

Based on these records, patterns (e.g., locations or environmental conditions) that tend to result in sensor calibration errors can be identified. For example, the processor may be configured to generate, based on historical records of sensor calibration errors, a consistency profile identifying at least one pattern that tends to result in calibration error. As the autonomous vehicle is planning or traveling along a route, locations and environmental conditions along the route can be compared to the consistency profile to determine if the route has any correlation with certain sensor calibration errors. If such a correlation is present, measures to correct calibration errors can be take proactively and/or alternative routes that do not have such a correlation can be considered. In some cases, these measures may be implemented by the autonomy computing system in real time. In other words, these measures may be performed during operation of the autonomous vehicle within a specified time constraint that enables the autonomous vehicle to be controlled based on these measures without any significant delay. Accordingly, the consistency profile enables the autonomous vehicle to operate in a way that reduces any adverse effect of sensor calibration errors on operation of the autonomous vehicle.

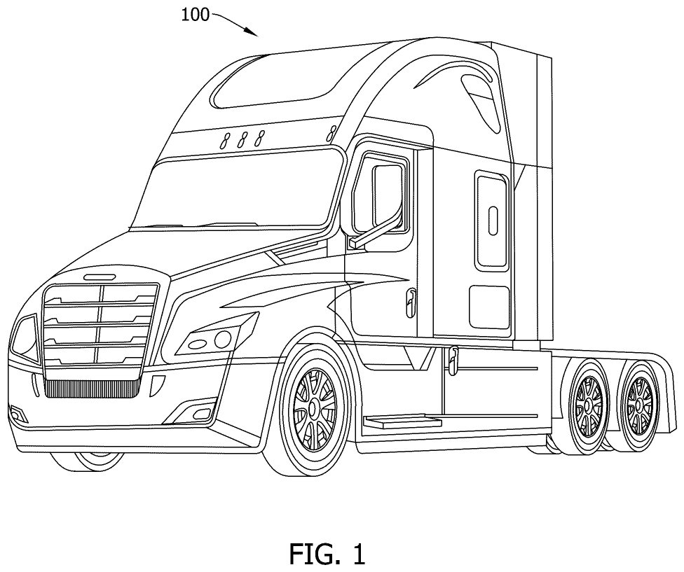

FIG. 1 is a schematic diagram of an autonomous vehicle 100. Autonomous vehicle 100 be part of a fleet of autonomous vehicles 100. The fleet of autonomous vehicles 100 generally travels in a limited geographic region or along a given set of routes. For example, the fleet may travel within a given county, or between location A and location B, along the same travel trajectories.

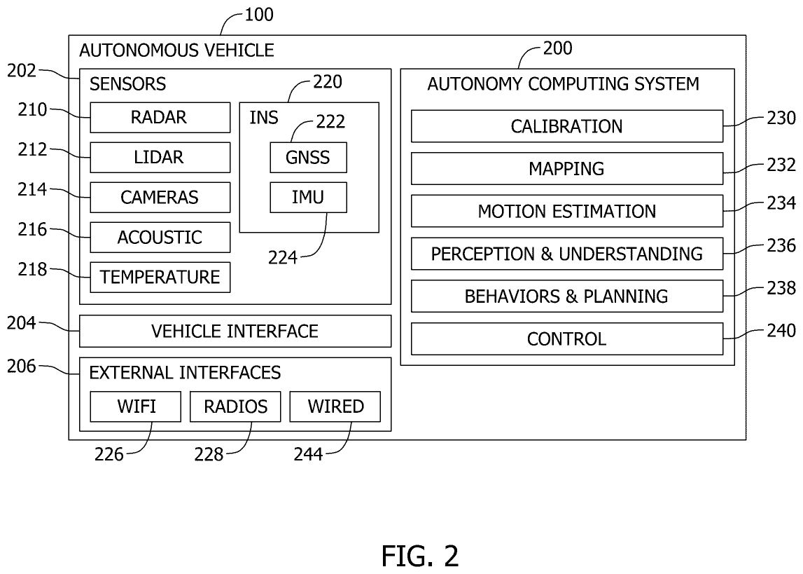

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

In the example embodiment, calibration module 230 is responsible for identifying when miscalibration occurs and taking corrective action. This process can be performed during operation of autonomous vehicle 100.

Calibration module 230 is configured to retrieve reference data indicating at least one baseline parameter. As described in further detail below, this reference data can be compared to sensor data to identify calibration errors. The baseline parameter may indicate, for example, known locations of reference features along a route to be traveled by autonomous vehicle 100. In some embodiments, this reference data is provided to calibration module 230 in a predefined manner, such as by using a digital map. Alternatively, in some embodiments, the reference data may be collected and/or generated over time. For example, the baseline parameter may be derived from historical sensor data collected by sensors 202 of autonomous vehicle 100 or similar autonomous vehicles in communication with autonomous vehicle 100. In such embodiments, the reference data may be updated over time to reflect changes in the actual environment.

Calibration module 230 is further configured to receive sensor data from sensors 202 during operation of autonomous vehicle 100. The sensor data indicating at least one measured parameter. For example, as described above, the baseline parameter may be a known location of a reference feature. In such cases, the measured parameter may be a perceived location of the reference feature, which can be compared to the known location of the reference feature to determine if a calibration error. While this disclosure uses identifying calibration errors in cameras such as cameras 214 as an example, it should be understood that sensor data may similarly be received from and used to identify calibration errors in any sensors of autonomous vehicle, including radar sensors 210, LiDAR sensors 212, various types of cameras 214, acoustic sensors 216, or temperature sensors 218, utilizing corresponding respective data types and features for the baseline parameter and measured parameter. For example, expected physical locations of reference features may be used to evaluate radar sensors 210, LiDAR sensors 212, cameras 214, expected sounds may be used to evaluate acoustic sensors 216, and expected temperature ranges may be used to evaluate temperature sensors 218.

Calibration module 230 is further configured to identify calibration errors of sensors 202 by comparing the measured or perceived parameter to the baseline or known parameter. In embodiments in which the analyzed sensor 202 is a camera 214, differences between the measured and baseline parameter may indicate certain intrinsic or extrinsic calibration errors. Examples of calibration errors relating to intrinsic parameters of camera 214 include errors relating to focal length, principal point, or distortion coefficients, and examples of calibration errors relating to intrinsic parameters of camera 214 include errors relating to a positioning of camera 214 with respect to a vehicle frame of autonomous vehicle 100.

When a calibration error is identified, calibration module 230 is further configured to generate a record including the calibration error. In addition to an identifier associated with the calibration error itself, the record may further include additional data such as a time stamp, a location, a misalignment type, or environmental data associated with the time and location at which the calibration error occurred. Examples of environmental data include lighting (e.g., day or night), road type (e.g., urban or rural, whether the road is a highway), weather, or whether any types of obstacles are present (e.g., buildings, vehicles, pedestrians, or construction).

Calibration module 230 is further configured to generate, based on historical records of identified calibration errors, a consistency profile identifying patterns that tends to result in certain calibration error. For example, a correlation may be identified between certain locations and/or environmental conditions and calibration errors that tend to occur under these conditions. In certain embodiments, sensor performance (e.g., whether or calibration errors developed and the magnitude of the errors) is evaluated over multiple drives and the consistency profile is continually updated as more information is gathered. In an example, calibration module 230 consistently detects radial distortion of a camera 214 when driving at certain locations or under certain conditions, and flags this as a pattern. In some embodiments, calibration module 230 is configured to utilize machine learning and/or artificial intelligence techniques for identifying these patterns.

Calibration module 230 is further configured to adjust appropriate parameters of sensors 202 based on the consistency profile to correct identified calibration errors and/or to proactively account for calibration errors that are likely to occur based on a current location and/or environment. In some embodiments, this adjustment is performed dynamically (e.g., in real time) during operation of autonomous vehicle 100. For example, if a focal length of a camera 214 is drifting over time from the original calibrated value, or if a radial distortion coefficient of a camera 214 is consistently increasing in a particular environment, camera 214 can automatically be recalibrated based on a current magnitude of the identified error, the consistency profile, and/or current environmental conditions of autonomous vehicle 100 to fix the calibration error and reduce a chance of the error occurring again.

In some embodiments, autonomy computing system 200 is configured to control operation of autonomous vehicle 100 based in part on the consistency profile. For example, during a route planning process, autonomy computing system 200 may compare a potential route to the consistency profile to determine if any locations or environmental conditions associated with the potential route are correlated with an occurrence of calibration errors, and may use this correlation as a factor in selecting a route.

In certain embodiments, the consistency profile is generated locally at autonomous vehicle 100 and/or based on sensor data collected by autonomous vehicle 100. In alternative embodiments, consistency profile may be generated at a remote location (e.g., at a central server based on data received from a plurality of autonomous vehicles 100) and be transmitted to one or more autonomous vehicles 100. This may enable, for example, comparing among autonomous vehicles to identify one autonomous vehicle that is different from the others and therefore likely has calibration errors. In further embodiments, a plurality of autonomous vehicles are configured to share sensor data and generate respective consistency profiles based on the shared sensor data, and/or may otherwise exchange data (e.g., locally generated consistency profiles) so that the consistency profile utilized by each autonomous vehicle 100 accounts for data collected by other autonomous vehicles 100.

In some embodiments, when an existing calibration error is identified by calibration module 230, autonomy computing system 200 is configured to generate an alert and transmit the alert via an external network (e.g., using external interfaces 206), for example, to a computing devices associated with an entity responsible for monitoring and/or maintaining autonomous vehicle 100. In cases where correcting a calibration error requires manual intervention, these alerts enable any identified calibration errors to be promptly addressed and any adverse impacts of the calibration errors on operation of autonomous vehicle 100 to be reduced. The alerts may include information relating to the type of calibration error, a severity of the error (e.g., whether the error affects operability of autonomous vehicle 100), a current location or other environmental conditions of autonomous vehicle 100, or other relevant information.

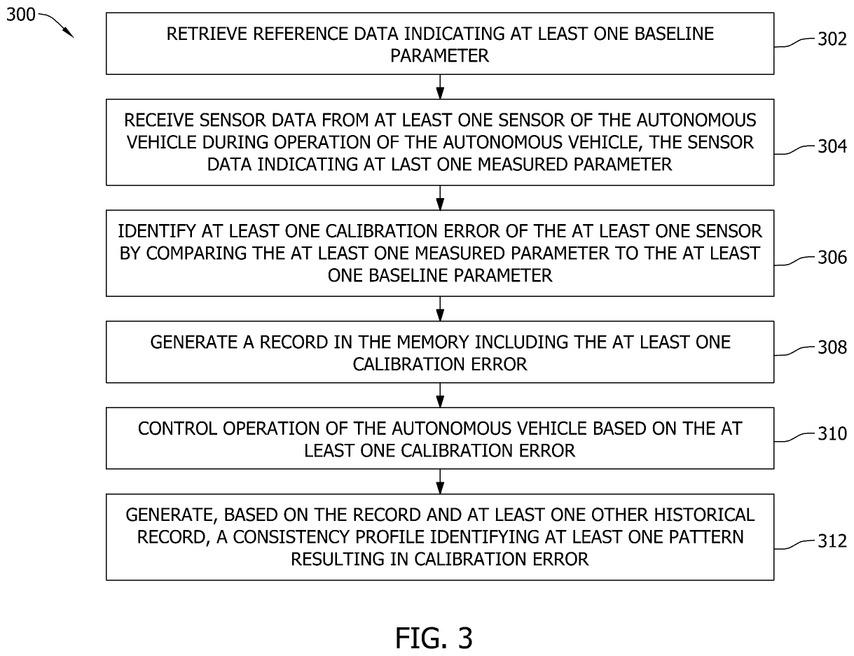

FIG. 3 is a flowchart illustrating an example method 300 for sensor calibration in autonomous vehicle 100. In the example embodiment, method 300 is performed by autonomy computing system 200 of autonomous vehicle 100.

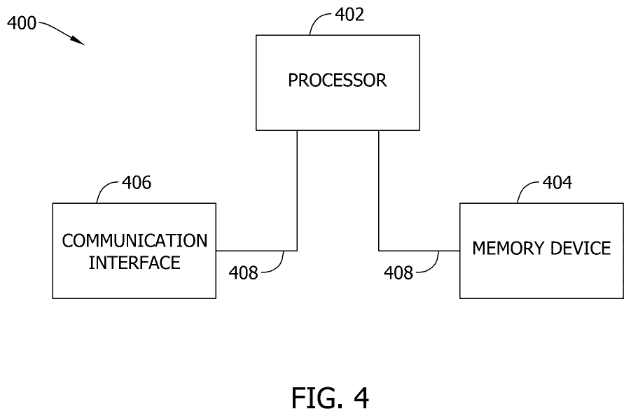

Autonomy computing system 200 retrieves 302 reference data indicating at least one baseline parameter. Autonomy computing system 200 receives 304 sensor data from at least one sensor 202 of autonomous vehicle 100 during operation of autonomous vehicle 100. The sensor data indicates at least one measured parameter. Autonomy computing system 200 identifies 306 at least one calibration error of the at least one sensor 202 by comparing the at least one measured parameter to the at least one baseline parameter. Autonomy computing system 200 generates 308 a record in a memory (such as memory device 404 described below with respect to FIG. 4) including the at least one calibration error. In some embodiments, the record further includes one or more of a time stamp, a location, a misalignment type, or environmental data. Autonomy computing system 202 further controls 310 operation of autonomous vehicle 100 based on the at least one calibration error

Autonomy computing system 200 generates 312, based on the record and at least one other historical record, a consistency profile identifying at least one pattern resulting in calibration error. In certain embodiments, autonomy computing system 200 adjusts at least one parameter of the at least one sensor 202 based on the consistency profile. In some such embodiments, the at least one parameter is adjusted in real time during operation of autonomous vehicle 100. In some embodiments, autonomous vehicle 100 is controlled based in part on the consistency profile. In certain embodiments, autonomy computing system 200 receives at least one other consistency profile of at least one other autonomous vehicle 100 in a fleet that includes autonomous vehicles 100 and adjusts at least one parameter of the at least one sensor 202 based on the consistency profile of autonomous vehicle 100 and the at least one other consistency profile

In certain embodiments, autonomy computing system 200, in response to identifying the at least one calibration error, transmit at least one alert via an external network (e.g., using external interface 206).

In some embodiments, the at least one baseline parameter includes a known position of at least one reference feature and the at least one measured parameter includes a perceived position of the at least one reference feature. In some such embodiments, the at least one baseline parameter is derived from historical sensor data.

FIG. 4 is a block diagram of an example computing device 400. Autonomy computing system 200 may be implemented with one or more computing devices 400. Computing device 400 includes a processor 402 and a memory device 404. The processor 402 is coupled to the memory device 404 via a system bus 408. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 404 includes one or more devices that enable information, such as executable instructions or other data (e.g., sensor data), to be stored and retrieved. Moreover, the memory device 404 includes one or more computer readable media, such as, without limitation, dynamic random access memory (DRAM), static random access memory (SRAM), a solid state disk, or a hard disk. In the example embodiment, the memory device 404 stores, without limitation, application source code, application object code, configuration data, additional input events, application states, assertion statements, validation results, or any other type of data. The computing device 400, in the example embodiment, may also include a communication interface 406 that is coupled to the processor 402 via system bus 408. Moreover, the communication interface 406 is communicatively coupled to data acquisition devices.

In the example embodiment, processor 402 may be programmed by encoding an operation using one or more executable instructions and providing the executable instructions in the memory device 404. In the example embodiment, the processor 402 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) an ability to identify sensor calibration errors during operation of an autonomous vehicle by comparing perceived sensor data to reference data, (b) an ability to generate real-time alerts indicating that sensor calibration errors are present for an autonomous vehicle by identifying the sensor calibration errors during operation of the autonomous vehicle, (c) identifying patterns such as locations and/or environmental factors that result in sensor calibration errors by generating and analyzing records associated with detected sensor calibration errors including contextual data, (d) proactively correcting sensor calibration errors based on patterns identified as being correlated with sensor calibration errors, and (e) controlling an autonomous vehicle such that sensor calibration errors are reduced by planning operation based in part on patterns identified as being correlated with sensor calibration errors.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An autonomy computing system for sensor calibration in an autonomous vehicle, the autonomy computing system comprising a processor and a memory in communication with the processor, the processor programmed to:
retrieve reference data indicating at least one baseline parameter;
receive sensor data from at least one sensor of the autonomous vehicle during operation of the autonomous vehicle, the sensor data indicating at least one measured parameter;
identify at least one calibration error of the at least one sensor by comparing the at least one measured parameter to the at least one baseline parameter;
generate a record in the memory including the at least one calibration error;
control operation of the autonomous vehicle based on the at least one calibration error;
generate, based on the record and at least one other historical record, a consistency profile identifying at least one pattern resulting in the at least one calibration error; and
adjust at least one parameter of the at least one sensor based on the consistency profile.

2. (canceled)

3. (canceled)

4. The autonomy computing system of claim 1, wherein the at least one parameter is adjusted in real time during operation of the autonomous vehicle.

5. The autonomy computing system of claim 1, wherein the autonomous vehicle is controlled based in part on the consistency profile.

6. The autonomy computing system of claim 1, wherein the processor is further programmed to:
receive at least one other consistency profile of at least one other autonomous vehicle in a fleet that includes the autonomous vehicle; and
adjust at least one parameter of the at least one sensor based on the consistency profile of the autonomous vehicle and the at least one other consistency profile.

7. The autonomy computing system of claim 1, wherein the processor is further programmed to, in response to identifying the at least one calibration error, transmit at least one alert via an external network.

8. The autonomy computing system of claim 1, wherein the at least one baseline parameter includes a known position of at least one reference feature and the at least one measured parameter includes a perceived position of the at least one reference feature.

9. The autonomy computing system of claim 1, wherein the processor is further programmed to:
derive the at least one baseline parameter from historical sensor data.

10. The autonomy computing system of claim 1, wherein the record further includes one or more of a time stamp, a location, a misalignment type, or environmental data.

11. A computer-implemented method for sensor calibration in an autonomous vehicle, the computer-implemented method comprising:
retrieving reference data indicating at least one baseline parameter;
receiving sensor data from at least one sensor of the autonomous vehicle during operation of the autonomous vehicle, the sensor data indicating at least one measured parameter;
identifying at least one calibration error of the at least one sensor by comparing the at least one measured parameter to the at least one baseline parameter;
generating a record in a memory including the at least one calibration error;
controlling operation of the autonomous vehicle based on the at least one calibration error;
generating, based on the record and at least one other historical record, a consistency profile identifying at least one pattern resulting in the at least one calibration error; and
adjusting at least one parameter of the at least one sensor based on the consistency profile.

12. (canceled)

13. (canceled)

14. The computer-implemented method of claim 11, wherein the at least one parameter is adjusted in real time during operation of the autonomous vehicle.

15. The computer-implemented method of claim 11, wherein the autonomous vehicle is controlled based in part on the consistency profile.

16. The computer-implemented method of claim 11, further comprising, in response to identifying the at least one calibration error, transmitting at least one alert via an external network.

17. The computer-implemented method of claim 11, wherein the at least one baseline parameter includes a known position of at least one reference feature and the at least one measured parameter includes a perceived position of the at least one reference feature.

18. The computer-implemented method of claim 11, further comprising deriving the at least one baseline parameter from historical sensor data.

19. The computer-implemented method of claim 11, wherein the record further includes one or more of a time stamp, a location, a misalignment type, or environmental data.

20. An autonomous vehicle comprising:
at least one sensor; and
an autonomy computing system comprising a processor and a memory in communication with the processor, the processor programmed to:
retrieve reference data indicating at least one baseline parameter;
receive sensor data from the at least one sensor of the autonomous vehicle during operation of the autonomous vehicle, the sensor data indicating at least one measured parameter;
identify at least one calibration error of the at least one sensor by comparing the at least one measured parameter to the at least one baseline parameter;
generate a record in the memory including the at least one calibration error;
control operation of the autonomous vehicle based on the at least one calibration error;
generate, based on the record and at least one other historical record, a consistency profile identifying at least one pattern resulting in the at least one calibration error; and
adjust at least one parameter of the at least one sensor based on the consistency profile.
